(19) United States
(12) Patent Application Publication
(10) Pub. No.: US 2023/0289964 A1
(43) Pub. Date: Sep. 14, 2023

(54) MEDICAL IMAGE PROCESSING APPARATUS, METHOD OF MEDICAL IMAGE PROCESSING, AND NON-TRANSITORY COMPUTER READABLE MEDIUM

(71) Applicants: Canon Kabushiki Kaisha, Tokyo (JP); CANON MEDICAL SYSTEMS CORPORATION, Tochigi (JP)

(72) Inventors: Yuta NARUKIYO, Ohta-ku (JP); Fukashi YAMAZAKI, Kawasaki (JP)

(73) Assignees: Canon Kabushiki Kaisha, Tokyo (JP); CANON MEDICAL SYSTEMS CORPORATION, Tochigi (JP)

(21) Appl. No.: 18/180,939

(22) Filed: Mar. 9, 2023

(30) Foreign Application Priority Data
Mar. 9, 2022 (JP) 2022-036241

(51) Int. Cl. G06T 7/00; G06T 5/00; G06T 7/50; G06V 10/25

(52) U.S. Cl. CPC G06T 7/0012; G06T 5/002; G06T 7/50; G06V 10/25; G06T 2207/30096

(57) ABSTRACT

An image processing apparatus according to an embodiment includes processing circuitry. The processing circuitry acquires an input image, infers a first region image about a first region included in the input image, generates a corrected image with the first region corrected from the first region image, and performs inference about a second region included in the input image based on the input image and the corrected image.

### CROSS-REFERENCE TO RELATED APPLICATIONS

This application is based upon and claims the benefit of priority from Japanese Patent Application No. 2022-036241 filed on Mar. 9, 2022, the entire contents of which are incorporated herein by reference.

### FIELD

Embodiments described herein relate generally to a medical image processing apparatus, a method of medical image processing, and a non-transitory computer readable medium.

### BACKGROUND

When extracting a certain region from a medical image by machine learning or the like, two-step extraction may be performed. There is a method that infers a region related to an object of interest in a first stage of extraction and then infers a target region with high accuracy in a second stage of extraction, for example. When inferring a pancreatic cancer region, for example, a pancreas region may be inferred from an image in the first stage of extraction, and a pancreatic cancer region may be inferred in the second stage of extraction. This procedure can reduce the range of search and calculation and avoid learning processing in machine learning from becoming complicated.

However, if errors occur due to loss of the region, boundary misrecognition, or the like in the first stage of extraction, these errors affect the second stage of extraction, and extraction of the target region may not be successful.

### BRIEF DESCRIPTION OF THE DRAWINGS

FIG. 1 is a diagram of an example of the configuration of a medical image processing apparatus according to an embodiment;

FIG. 2 is a diagram of an example of the configuration of an X-ray CT apparatus including the medical image processing apparatus according to the embodiment;

FIG. 3 is a flowchart of an example of processing performed by the medical image processing apparatus according to a first embodiment;

FIG. 4 is a diagram illustrating the processing performed by the image processing apparatus according to the first embodiment;

FIG. 5 is a diagram illustrating the processing performed by the image processing apparatus according to the first embodiment;

FIG. 6 is a diagram illustrating the processing performed by the image processing apparatus according to the first embodiment;

FIG. 7 is a diagram illustrating an example of an inference result performed by the image processing apparatus according to the first embodiment;

FIG. 8 is a flowchart of an example of processing performed by the image processing apparatus according to a second embodiment; and

FIG. 9 is a flowchart of an example of processing performed by the image processing apparatus according to a third embodiment.

### DETAILED DESCRIPTION

A medical image processing apparatus provided in one aspect of the present invention includes processing circuitry. The processing circuitry acquires an input image, infers a first region image about a first region included in the input image, generates a corrected image with the first region corrected from the first region image, and performs inference about a second region included in the input image based on the input image and the corrected image.

The following describes embodiments of an image processing apparatus, a method of image processing, and a non-transitory computer readable medium in detail with reference to the accompanying drawings.

### First Embodiment

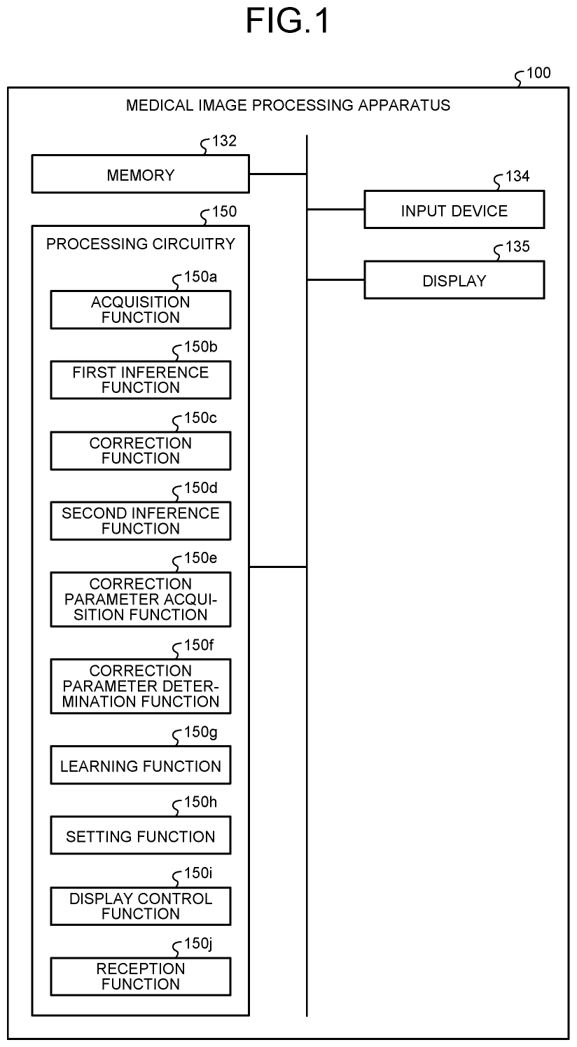

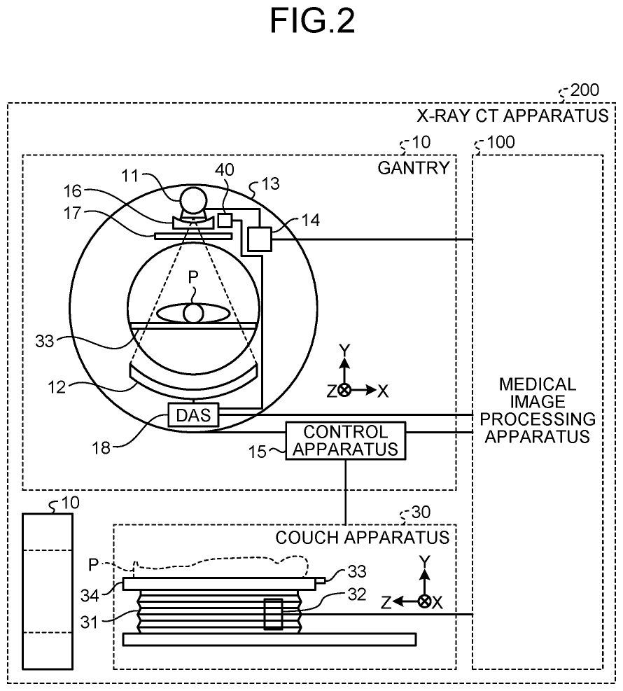

The following first describes a configuration example of a medical image processing apparatus and an X-ray computer tomography (CT) apparatus according to an embodiment using FIG. 1 and FIG. 2. FIG. 1 is a diagram of a medical image processing apparatus 100 according to the embodiment. FIG. 2 is a diagram of an example of a medical image diagnostic apparatus incorporating the medical image processing apparatus 100 according to the embodiment. FIG. 2 illustrates a case in which the medical image diagnostic apparatus incorporating the medical image processing apparatus 100 is an X-ray CT apparatus 200. However, embodiments are not limited to the case in which the medical image diagnostic apparatus is the X-ray CT apparatus 200, and the medical image diagnostic apparatus may be any other medical image diagnostic apparatuses such as an ultrasonic diagnostic apparatus, a magnetic resonance imaging apparatus, and a positron emission tomography (PET) diagnostic apparatus. The medical image processing apparatus according to the embodiment is not necessarily incorporated into the medical image diagnostic apparatus and may function independently as a medical image processing apparatus.

In FIG. 1, the medical image processing apparatus 100 includes a memory 132, an input device 134, a display 135, and processing circuitry 150. The processing circuitry 150 includes an acquisition function 150a, a first inference function 150b, a correction function 150c, a second inference function 150d, a correction parameter acquisition function 150e, a correction parameter determination function 150f, a learning function 150g, a setting function 150h, a display control function 150i, and a reception function 150j.

In the embodiment, each processing function performed by the acquisition function 150a, the first inference function 150b, the correction function 150c, the second inference function 150d, the correction parameter acquisition function 150e, the correction parameter determination function 150f, the learning function 150g, the setting function 150h, the display control function 150i, and the reception function 150j is stored in the memory 132 in the form of a computer program executable by a computer. The processing circuitry 150 is a processor reading the computer program from the memory 132 and executing it to implement the function corresponding to each computer program. In other words, the processing circuitry 150 having read each computer program has each function shown in the processing circuitry 150.

Although the above in FIG. 1 describes a case in which the single processing circuitry 150 implements the processing functions performed by the acquisition function 150a, the first inference function 150b, the correction function 150c, the second inference function 150d, the correction parameter acquisition function 150e, the correction parameter determination function 150f, the learning function 150g, the setting function 150h, the display control function 150i, and the reception function 150j, a plurality of independent processors may be combined with each other to form the processing circuitry 150, and each of the processors may execute the computer program to implement the function. In other words, each of the functions described above may be configured as a computer program, and one processing circuitry 150 may execute each computer program. As another example, a specific function may be implemented in a dedicated, independent program execution circuit. In FIG. 1, the acquisition function 150a, the first inference function 150b, the correction function 150c, the second inference function 150d, the correction parameter acquisition function 150e, the correction parameter determination function 150f, the learning function 150g, the setting function 150h, the display control function 150i, and the reception function 150j are examples of an acquisition unit, a first inference unit, a correction unit, a second inference unit, a correction parameter acquisition unit, a correction parameter determination unit, a learning unit, a setting unit, a display control unit, and a reception unit, respectively. The display 135 is an example of a display.

The term “processor” used in the above description means, for example, a circuit such as a central processing unit (CPU), a graphical processing unit (GPU), an application specific integrated circuit (ASIC), a programmable logic device (for example, a simple programmable logic device (SPLD), a complex programmable logic device (CPLD), or a field programmable gate array (FPGA)). The processor reads a computer program stored in the memory 132 and executes it to implement a function.

In place of storing the computer program in the memory 132, the computer program may directly be embedded in the circuitry of the processor. In this case, the processor reads the computer program embedded in the circuitry and executes it to implement its function.

The processing circuitry 150 acquires various information from the medical image diagnostic apparatus by the acquisition function 150a. The processing circuitry 150 also performs various processing described below by the first inference function 150b, the correction function 150c, the second inference function 150d, the correction parameter acquisition function 150e, the correction parameter determination function 150f, and the setting function 150h.

The processing circuitry 150 performs machine learning and generates a learned model by the learning function 150g. The processing circuitry 150 controls generation, display, and the like of images by the display control function 150i. As an example, the processing circuitry 150 causes the display 135 to display various generated images by the display control function 150i. In addition, the processing circuitry 150 may perform overall control of the medical image diagnostic apparatus from which the medical image processing apparatus 100 acquires data by the display control function 150i.

The processing circuitry 150 receives various processing from a user through the input device 134, for example, by the reception function 150j.

The functions described above are only by way of example, and the processing circuitry 150 is not required to have all the functions enumerated herein.

The memory 132 stores therein data acquired from the medical image diagnostic apparatus, image data generated by the processing circuitry 150, and the like. The memory 132 is a semiconductor memory element such as a random access memory (RAM) or a flash memory, a hard disk, or an optical disc, for example.

The input device 134 receives various instructions and information input from an operator. The input device 134 is a pointing device such as a mouse or a trackball, a selection device such as a mode switch, or an input device such as a keyboard, for example. The display 135 displays a graphical user interface (GUI) for receiving imaging conditions, images generated by the processing circuitry 150, and the like under the control of the processing circuitry 150 having the display control function 150i. The display 135 is a display device such as a liquid crystal display, for example.

FIG. 2 illustrates an example of the X-ray CT apparatus 200 incorporating the medical image processing apparatus 100 according to the present embodiment.

As illustrated in FIG. 2, the X-ray CT apparatus 200 includes a gantry 10, a couch apparatus 30, and the medical image processing apparatus 100, for example.

In FIG. 2, the axis of rotation of a rotating frame 13 in a non-tilted state or the longitudinal direction of a couchtop 33 of the couch apparatus 30 is defined as a Z-axis direction. An axial direction orthogonal to the Z-axis direction and horizontal to the floor surface is defined as an X-axis direction. An axial direction orthogonal to the Z-axis direction and perpendicular to the floor surface is defined as a Y-axis direction.

The gantry 10 applies X-rays to a subject P, which is a patient or the like, and detects the X-rays having passed through the subject P and outputs them to the medical image processing apparatus 100. Specifically, the gantry 10 includes an X-ray tube 11, an X-ray detector 12, the rotating frame 13, an X-ray high voltage apparatus 14, a control apparatus 15, a wedge 16, an X-ray iris 17, and a data acquisition system (DAS) 18. For convenience of illustration, FIG. 2 illustrates the gantry 10 viewed from the X-axis direction and the gantry 10 viewed from the Z-axis direction, but in reality, the X-ray CT apparatus includes a single gantry 10.

The X-ray tube 11 is a vacuum tube having a cathode (filament) generating thermoelectrons and an anode (target) generating X-rays upon collision with the thermoelectrons. Specifically, the X-ray tube 11 applies the thermoelectrons from the cathode toward the anode by the application of high voltage from the X-ray high voltage apparatus 14 to generate X-rays. The X-ray tube 11 is a rotating anode type X-ray tube generating X-rays by applying hot electrons onto a rotating anode, for example.

The X-ray detector 12 has a plurality of detection elements detecting the X-rays emitted from the X-ray tube 11 and having passed through the subject P, and each detection element outputs an electric signal corresponding to a detected X-ray dose to the DAS 18. Specifically, the X-ray detector 12 has a structure having a plurality of detection element rows in which a plurality of detection elements are arranged in a channel direction along the circumferential direction of an arc centered on the focus of the X-ray tube 11, in which the detection element rows are arranged in a slice direction (also called a row direction).

The X-ray detector 12 is an indirect conversion type detector having a collimator, a scintillator array, and a detection element array, for example. The collimator is disposed on the face on the X-ray incidence side of the scintillator array and has an X-ray shielding plate absorbing scattered X-rays. The collimator is a one-dimensional or a two-dimensional collimator, for example. The collimator is also called a grid. The scintillator array is disposed on the face on the X-ray incidence side of the detection element array and has a plurality of scintillators. Each scintillator has a scintillator crystal outputting light with a photon amount corresponding to the dose of X-rays having been made incident. The detection element array has a plurality of detection elements, and each detection element converts the light output from the scintillator into an electric signal corresponding to the light amount of the light. The detection element array includes a plurality of subarrays, in which a plurality of detection elements are arranged in one dimension (n rows×1 column) or two dimensions (n rows×m columns) on the same plane, are disposed arranged in a channel direction and a slice direction, for example. The detection element is a light-receiving element such as a photo diode (PD) or a photomultiplier tube (PMT), for example.

The rotating frame 13 is an annular frame rotating the X-ray tube 11 and the X-ray detector 12 about the axis of rotation (the Z-axis). Specifically, the rotating frame 13 is supported by a fixed frame (not illustrated) in a rotatable manner about the axis of rotation with the X-ray tube 11 and the X-ray detector 12 supported opposite each other. The rotating frame 13 rotates about the axis of rotation under control by the control apparatus 15 and thereby rotates the X-ray tube 11 and the X-ray detector 12 about the axis of rotation. In addition to the X-ray tube 11 and the X-ray detector 12, the rotating frame 13 further includes and supports the X-ray high voltage apparatus 14 and the DAS 18.

The X-ray high voltage apparatus 14 has a high voltage generation apparatus having an electric circuit such as a transformer and a rectifier and having a function of generating high voltage to be applied to the X-ray tube 11 and an X-ray control apparatus controlling output voltage corresponding to X-ray output to be applied by the X-ray tube 11. The high voltage generation apparatus may be of the transformer system or of the inverter system. The X-ray high voltage apparatus 14 may be provided in the rotating frame 13 or provided in the fixed frame (not illustrated) rotatably supporting the rotating frame 13 within the gantry 10.

The wedge 16 is a filter for regulating the dose of the X-rays applied from the X-ray tube 11. Specifically, the wedge 16 is a filter passing and attenuating the X-rays applied from the X-ray tube 11 in such a manner that the X-rays applied from the X-ray tube 11 to the subject P have preset distribution. The wedge 16 is a filter made of aluminum machined to have a certain target angle and a certain thickness, for example. The wedge 16 is also called a wedge filter or a bow-tie filter.

The X-ray iris 17 includes a lead plate or the like to narrow down the application range of the X-rays having passed through the wedge 16 and forms a slit by combining a plurality of lead plates or the like with each other.

The DAS 18 is processing circuitry generating detection data based on the electric signals output from the respective detection elements of the X-ray detector 12. Specifically, the DAS 18 amplifies the electric signals output from the respective detection elements of the X-ray detector 12 and converts the amplified electric signals from analog signals to digital signals to generate detection data. The detection data generated by the DAS 18 is transmitted by optical communication from a transmitter having a light emitting diode (LED) provided in the rotating frame 13 to a receiver having a photodiode provided in a non-rotating part (a support frame, for example) of the gantry 10 and is transferred to the medical image processing apparatus 100. The method for transmitting the detection data from the rotating frame 13 to the non-rotating part of the gantry 10 is not limited to optical communication, but any non-contact method of data transmission may be employed.

The control apparatus 15 has a drive mechanism including a motor and an actuator and processing circuitry controlling the drive mechanism. The control apparatus 15 has a function of receiving input signals from an input interface mounted on the medical image processing apparatus 100 or the gantry 10 to perform operation control of the gantry 10 and the couch apparatus 30. The control apparatus 15 performs, upon reception of the input signals, control to rotate the rotating frame 13, control to tilt the gantry 10, and control to operate the couch apparatus 30 and the couchtop 33, for example.

The couch apparatus 30 is an apparatus for placing and moving the subject P to be scanned and includes a base 31, a couch drive apparatus 32, the couchtop 33, and a support frame 34. The base 31 is a housing supporting the support frame 34 in a vertically movable manner. The couch drive apparatus 32 is a motor or an actuator moving the couchtop 33 on which the subject P is placed in the direction of the long axis of the couchtop 33. The couchtop 33 provided on the top face of the support frame 34 is a plate on which the subject P is placed. In addition to the couchtop 33, the couch drive apparatus 32 may move the support frame 34 in the direction of the long axis of the couchtop 33.

The following briefly describes a background according to the embodiment.

When extracting a certain region from a medical image by machine learning or the like, two-step extraction may be performed. There is a method that infers a region related to an object of interest in a first stage of extraction and then infers a target region with high accuracy in a second stage of extraction, for example. When inferring a pancreatic cancer region, for example, a pancreas region may be inferred from an image in the first stage of extraction, and a pancreatic cancer region may be inferred in the second stage of extraction. This procedure can reduce the range of search and calculation and avoid learning from becoming complicated.

However, if errors occur due to loss of the region, boundary misrecognition, or the like in the first stage of extraction, these errors affect the second stage of extraction, and extraction of the target region may not be successful.

The medical image processing apparatus according to the embodiment reflects such background, and the medical image processing apparatus according to the embodiment includes an acquisition unit, a first inference unit, a correction unit, and a second inference unit. The acquisition unit acquires an input image. The first inference unit infers a first region image about a first region included in the input image. The correction unit generates a corrected image with the first region corrected from the first region image. The second inference unit performs inference about a second region included in the input image based on the input image and the corrected image.

This procedure can mitigate the influence of an inference error in the first stage of extraction and improve inference accuracy.

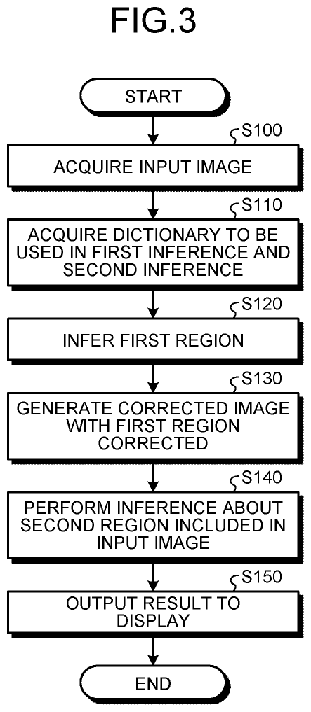

The following describes such a configuration using FIG. 3 to FIG. 8.

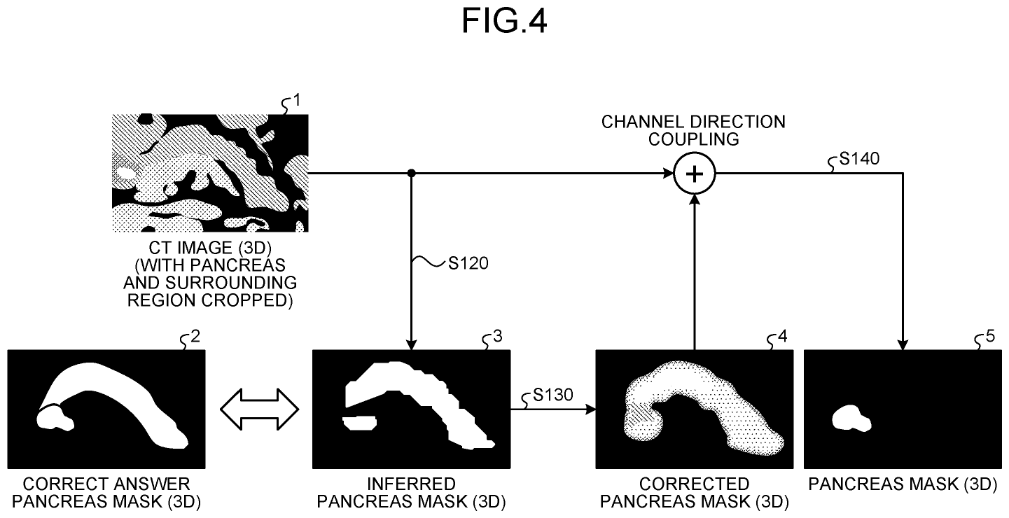

FIG. 3 is a diagram of a procedure of processing performed by the medical image processing apparatus 100 according to the first embodiment. FIG. 4 is a diagram illustrating an overall picture of the processing performed by the medical image processing apparatus 100 according to the first embodiment.

At Step S100, the processing circuitry 150 acquires an input image from a medical image processing apparatus, an external database, a storage device, or the like by the acquisition function 150a. As an example, when the medical image processing apparatus is the X-ray CT apparatus 200, the processing circuitry 150 acquires a CT image from the X-ray CT apparatus 200 as an input image 1 illustrated in FIG. 4 by the acquisition function 150a. When an object to be imaged is the pancreas, the processing circuitry 150 acquires a three-dimensional CT image with the pancreas and the surrounding region cropped, for example, as the input image 1 from the X-ray CT apparatus 200 by the acquisition function 150a. As another example, the processing circuitry 150 acquires an original image of the pancreas and the surrounding region, for example, as the input image 1 from the X-ray CT apparatus 200 by the acquisition function 150a. The input image 1 is a three-dimensional CT image having 512×512×N pixels, in which N is the number of slices, for example.

The input image 1 may be an image with preprocessing such as resolution conversion and grayscale conversion performed. When the resolution conversion is performed as the preprocessing, the input image 1 is a three-dimensional CT image having 160×96×128 pixels, for example.

Equation (1) below shows an example of the grayscale conversion. That is, the processing circuitry 150 executes grayscale conversion on a CT image before preprocessing by a preprocessing function, not illustrated, in such a manner that a density value range (−115 to +235 HU) expressed by window level=60 and window width=350 is 0.0 to 1.0 as shown in Equation (1) below, for example. These values vary depending on an observation site, a subject, the phase of observation, or the like.

$${I}_{after conversion} ( i , j , k ) = \{ \begin{matrix}1. & ( {I}_{before conversion} ( i , j , k ) \geq + 235 HU ) \\ 0. & ( {I}_{before conversion} ( i , j , k ) \leq - 115 HU ) \\ \frac{{I}_{before conversion} ( i , j , k ) - WL + \frac{WW}{2.}}{WW} & ( others )\end{matrix} \qquad ( 1 )$$

where I_{after conversion} and I_{before conversion} are signal intensities of the CT image after the grayscale conversion and before the grayscale conversion, respectively; i, j, and k are pixel indices; and WL and WW represent a window level and a window width, respectively.

The grayscale conversion here may be such that the data after the grayscale conversion has a grayscale equivalent to that when the processing circuitry 150 performs second inference by the second inference function 150d at Step S140 described below, for example. This grayscale conversion enables the processing circuitry 150 to perform efficient data processing.

Next, at Step S110, the processing circuitry 150 acquires a dictionary to be used in first inference and the second inference by the acquisition function 150a. That is, the processing circuitry 150 acquires a model structure and parameters to be used in the first inference and the second inference described below by the acquisition function 150a. The processing circuitry 150 may acquire the model structure itself by the acquisition function 150a, or, as another example, the model structure itself may be implemented by the first inference function 150b or the like, and the processing circuitry 150 may acquire only the parameters by the acquisition function 150a. The model structure used in the first inference and the model structure and the parameters used in the second inference are generally different from each other. A model is an inference instrument that can determine a boundary based on feature amounts such as image luminance, luminance difference, and luminance distribution, as represented by a convolutional neural network (CNN) or a random forest using decision trees, for example. The model structure acquired by the processing circuitry 150 at Step S110 includes, for CNN, the number of times of convolutions, the number of filters, the number of channels of each layer, the number of times of down-samplings, and layer connection information and, for the random forest, the number of decision trees, the positions of nodes, and depth information. Next, examples of the parameters acquired by the processing circuitry 150 at Step S110 include, when the model structure is CNN, for example, filters and bias values and, when the model structure is the random forest (RF), thresholds for branches of the decision trees.

Next, at Step S120, the processing circuitry 150 infers the first region by the first inference function 150b. That is, as illustrated in FIG. 4, the processing circuitry 150 performs the processing at Step S120, which is the first inference on the input image 1, to infer a first region image 3 about the first region included in the input image 1 by the first inference function 150b. The first region image 3 is a region mask image, which is an image for extracting the first region from the input image 1, for example. The first region image 3 is an image with binarization processing executed so as to give a value of 1 for the first region and a value of 0 for the other region, for example.

That is, the processing circuitry 150 infers the region mask image, which is an image for extracting the first region, as the first region image 3 based on the input image 1 by the first inference function 150b. The first region is information narrowing down the search range of the second region to be detected.

When the purpose of the second inference is to extract a pancreatic cancer region, for example, that is, when the second region to be detected is the pancreatic cancer region, the first region is a pancreas region, for example. The first region image 3 is an inferred pancreas mask image showing a mask region of the pancreas region in three dimensions, for example. The first region, which is the mask region of the pancreas region, is a useful region for narrowing down the second region, which is the pancreatic cancer region to be detected.

The first region may include a region that is known not to include the second region. As an example, when the second region is the pancreatic cancer region, the processing circuitry 150 may estimate a region that may contribute to identifying the pancreas region, the region including regions other than the pancreas, such as regions of the duodenum, the spleen, and the stomach, as the first region and infer the first region image 3 by the first inference function 150b. That is, regions other than the pancreas do not contain pancreatic cancer but may be useful for identifying pancreatic cancer, and thus, depending on embodiments, the processing circuitry 150 may include these regions as well in the first region.

As specific processing at Step S120, the processing circuitry 150 may use a learned model of a three-dimensional CNN, for example, from the input image 1 by the first inference function 150b. The processing circuitry 150 infers the first region image 3 using an encoder-decoder network model such as U-net, for example, from the input image 1 by the first inference function 150b. In this case, in general, on the encoder side, an input image is gradually reduced, and image features are extracted, and on the decoder side, a desired region image is generated from the extracted image features. Before executing the learned model, the processing circuitry 150 executes learning of the learned model for use in the first inference in advance by the learning function 150g.

When the input image 1 is a three-dimensional image, the processing circuitry 150 may use a U-net-based three-dimensional CNN by the first inference function 150b, but embodiments are not limited to the case in which the input image 1 is a three-dimensional image. When the input image 1 is a two-dimensional image, the processing circuitry 150 can also infer the first region image 3 by performing the same processing by the first inference function 150b.

Next, at Step S130, the processing circuitry 150 generates a corrected image with the first region inferred at Step S120 corrected by the correction function 150c. As illustrated in FIG. 4, the processing circuitry 150 performs the processing at Step S130 on the first region image 3 by the correction function 150c to generate a corrected image 4 with the first region corrected. As an example, the processing circuitry 150 generates the corrected image 4 with the shape or distribution of the first region corrected from the first region image 3 by the correction function 150c.

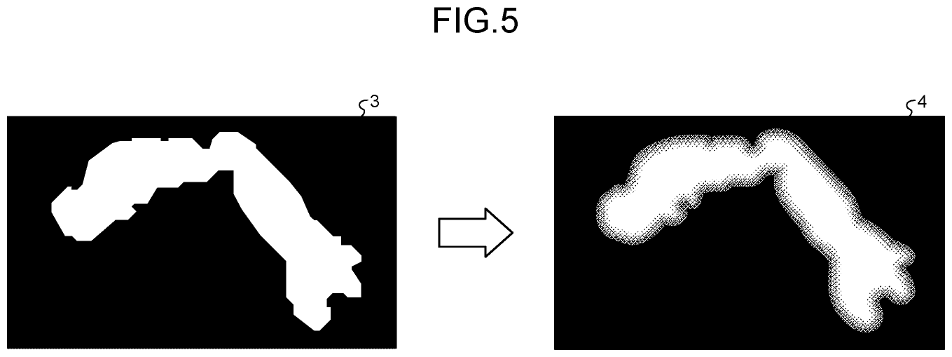

As an example, the processing circuitry 150 performs processing to blur the first region image 3, that is, processing to increase the ambiguity of the shape of the first region image 3 or the ambiguity of the distribution of the first region image 3 at Step S130 by the correction function 150c to generate the corrected image 4. As illustrated in FIG. 5, for example, the processing circuitry 150 performs blurring processing on the first region image 3, which is the pancreas mask image inferred at Step S120, by the correction function 150c to generate a three-dimensional corrected pancreas mask image as the corrected image 4.

Now, to explain the meaning of generating the corrected image 4 by performing the blurring processing, for example, by the processing circuitry 150 at Step S130, in machine learning using a gradient method such as the CNN, if additional information other than the input image is given, learning proceeds in a direction that is highly dependent on the additional information. Thus, in FIG. 4, for example, when a mask image 5, which is an image of the pancreatic cancer region, is attempted to be generated based on the input image 1 and the first region image 3, the learning tends to be performed in a way that is highly dependent on the information on the first region image 3. However, a correct answer image 2, which is an image representing the correct pancreas region, and the first region image 3 are generally different from each other. Comparing the first region image 3 and the correct answer image 2 with each other, the pancreas region is partially missing in the first region image 3, for example. Under such circumstances, when the learning heavily relying on the information on the first region image 3, which is different from the correct answer image 2, is performed, the quality of the mask image 5 to be output as a result will be degraded.

Thus, at Step S130, the processing circuitry 150 intentionally performs the blurring processing on the first region image 3 by the correction function 150c to generate the corrected image 4. When the mask image 5 is generated based on the input image 1 and the corrected image 4, the corrected image 4 remains ambiguous compared to the first region image 3. In conventional mask images with binary values, pixel values at the boundary positions of the first region are discontinuous. In CNN learning, in general, the difference between a correct answer image and an output image is taken, and learning proceeds in a direction of reducing the difference, and thus a large difference occurs at a position in which the boundary is clear. Thus, an excessive gradient may occur on the boundary during learning, leading to strong recognition of a boundary region, which may result in destabilization of the learning. However, when the corrected image 4 with the blurring processing performed is used, the pixel values at the boundary positions of the first region will be smooth, continuous values, and thus it is expected that the excessive gradient will be reduced. Thus, although the additional information is used to some extent in the process of generating the mask image 5, it is used only to roughly narrow down the search range. Consequently, errors in the first region image 3 are less likely to affect the quality of the mask image 5, thus stabilizing the quality of the mask image 5. In addition, the correction processing performed at Step S120 is also region growing for the additional information and thus also has a role of complementing the data of lost parts.

Thus, for such a purpose, at Step S130, the processing circuitry 150 generates the corrected image 4 with the first region corrected by the correction function 150c.

The following describes the details of the blurring processing at Step S130. As an example, the processing circuitry 150 performs the blurring processing by applying a Gaussian filter to the first region image 3 by the correction function 150c to generate the corrected image 4.

Specifically, the processing circuitry 150 performs the blurring processing using a Gaussian filter given by Equation (2) below, for example, to generate the corrected image 4.

$$f ( x , y , z ) = \frac{1}{{( \sqrt{2 π} )}^{3} {σ}^{3}} exp ( - \frac{{x}^{2} + {y}^{2} + {z}^{2}}{2 {σ}^{2}} ) \qquad ( 2 )$$

where Equation (2) is a three-dimensional filter; x, y, and z represent a position from a filter center in the filter; σ is a parameter representing a blurring amount of the filter; and f(x, y, z) represents each element value of the filter at a position of x, y, and z.

Now, considering a case in which the blurring amount σ is 3, for example, the filter uses a 3σ interval of the normal distribution, and thus the size N of the Gaussian filter is N=3×σ×2+1, that is, the filter spreads from a central point of the filter to the 3σ interval on the right and left. That is, when the blurring amount σ=3, the Gaussian filter is a filter in which for each of nine pixels on the front, rear, left, right, top, and bottom of a pixel of interest, its element value is given by Equation (2). The processing circuitry 150 applies a Gaussian filter with a filter size of N×N×N given by Equation (2) to each element point of the first region image 3 and adds up the results of the application to generate the corrected image 4.

The above example has been described with the blurring amount σ=3, but examples are not limited to this example, and the processing circuitry 150 may generate the corrected image 4 with a value different from σ=3 as the value of the blurring amount σ by the correction function 150c. The blurring amounts in the x, y and z respective axis directions are not necessarily required to be the same, and the corrected image 4 may be generated using blurring amounts different for the respective axis directions.

The dimension of the Gaussian filter is not limited to the three-dimensional filter described above and may be a two-dimensional filter or a one-dimensional filter, for example. In the case of the two-dimensional filter, the processing circuitry 150 generates the corrected image 4 using a two-dimensional Gaussian filter shown in Equation (3) below, for example.

$$f ( x , y ) = \frac{1}{2 {πσ}^{2}} exp ( - \frac{{x}^{2} + {y}^{2}}{2 {σ}^{2}} ) \qquad ( 3 )$$

The dimension of the filter is not required to match the dimension of the first region image 3. As an example, the processing circuitry 150 may generate the corrected image 4 by applying a one-dimensional Gaussian filter to the first region image 3, which is a three-dimensional image, in each of the x, y, and z directions in turn by the correction function 150c.

These pieces of correction processing are processing to mitigate the influence of an inference error of the first region image 3 by the second inference function 150d described below.

Next, at Step S140, the processing circuitry 150 infers a second region image, which is an image of the second region included in the input image, by the second inference function 150d. That is, the processing circuitry 150 performs the second inference by the second inference function 150d.

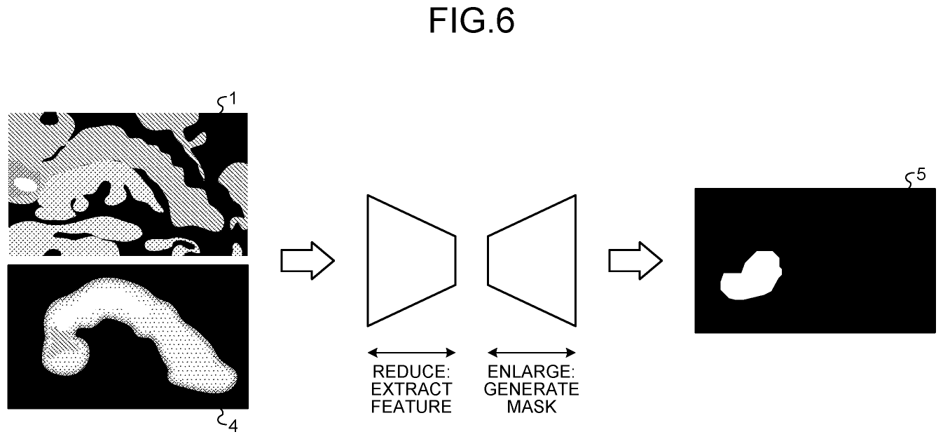

As an example, as illustrated in FIG. 4 and FIG. 6, the processing circuitry 150 performs the processing at Step S140 on the input image 1 and the corrected image 4 generated at Step S130 by the second inference function 150d, performs the inference about the second region in the input image 1 based on the learned model, and generates the mask image 5, for example, as an inference result.

As an example, when the first region is the pancreas region and the second region is the pancreatic cancer region, the processing circuitry 150 inputs the input image 1, which is an X-ray CT image, and the corrected image 4, which is a pancreas region correction mask generated at Step S130, to the learned model by the second inference function 150d to infer the pancreatic cancer region, which is the second region included in the input image 1. The processing circuitry 150 infers the pancreatic cancer region, which is the second region included in the input image 1, from the input image 1 and the corrected image 4 by the learned model including a certain neural network including an encoder-decoder structure, for example, by the second inference function 150d, for example.

As an example, the processing circuitry 150 generates the mask image 5, which is a binary image with data binarized by 0 or 1, from the input image 1 and the corrected image 4, with a pixel inferred as the pancreatic cancer region being 1 and a pixel not inferred as the pancreatic cancer region being 0 by the second inference function 150d, for example.

Next, at Step S150, the processing circuitry 150 causes the display 135 as the display to display the data obtained as a result of the inference performed at Step S140 by the display control function 150i.

As an example, the processing circuitry 150 causes the display 135 as the display to display the mask image 5, which is the binary image generated at Step S140, by the display control function 150i.

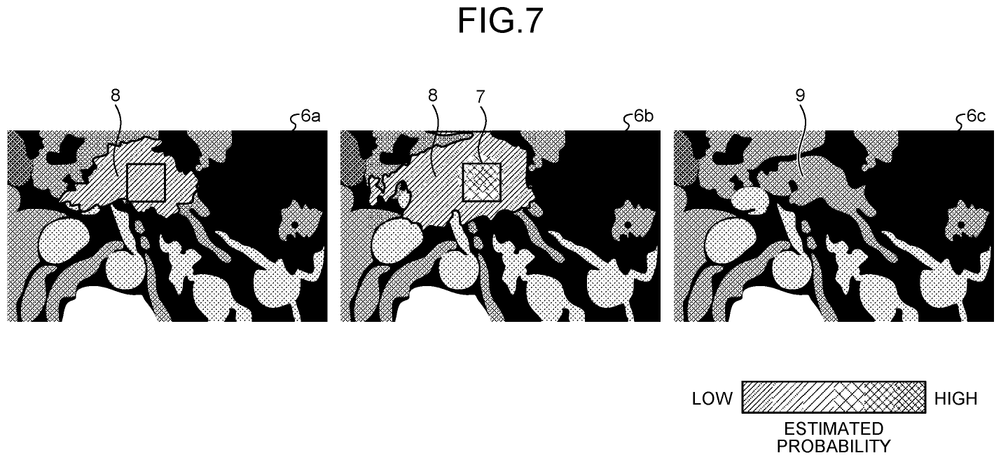

FIG. 7 illustrates an example of the inference result performed by the medical image processing apparatus 100 according to the embodiment. An image 6c is a CT image and is a region including a pancreas 9. The pancreatic cancer region was extracted for both the case of without the correction processing and the case of with the correction processing at Step S130 of the embodiment. An image 6a is an image obtained by extracting the pancreatic cancer region without the correction processing at Step S130. A region 8 was extracted as a region of being pancreatic cancer with a low probability, not succeeding in extraction of pancreatic cancer. An image 6b, on the other hand, is an image obtained by extracting the pancreatic cancer region with the correction processing at Step S130. The region 8 was extracted as a region of being pancreatic cancer with a low probability, and in addition, a region 7 was extracted as a region of being pancreatic cancer with a high probability, succeeding in extraction of pancreatic cancer.

As described above, in the first embodiment, the processing circuitry 150 infers the first region image about the first region included in the input image by the first inference function 150b, then generates the corrected image with the first region corrected from the first region image by the correction function 150c, and then performs the inference about the second region included in the input image based on the input image and the corrected image by the second inference function 150d. This procedure can mitigate the influence of the first stage of inference error in the two-stage inference to improve inference accuracy.

### First Modification of First Embodiment

Embodiments are not limited to the above example. The above example describes a case in which the first region image 3 that the processing circuitry 150 infers by the first inference function 150b at Step S120 is a binarized image, but embodiments are not limited to this example. As an example, at Step S120, the processing circuitry 150 may infer a likelihood image in which each pixel shows a value representing a probability of being the pancreas region as the first region image 3 by the first inference function 150b.

At Step S140, the processing circuitry 150 may generate a likelihood image in which each pixel shows a value representing a probability of being the pancreatic cancer region as the mask image 5 by the second inference function 150d. In this case, each element of the mask image 5 will have a continuous value of 0 or more and 1 or less. Embodiments are not limited to this example, and each element of the mask image 5 may be other than a value of 0 or more and 1 or less.

At Step S150, the processing circuitry 150 may perform binarization processing on the mask image 5, which is the likelihood image generated at Step S140, by the display control function 150i and then cause the display 135 as the display to display data after the binarization processing. The processing circuitry 150 performs binarization processing in the mask image 5, which is the likelihood image, with 0.5 as a threshold and with a pixel value not less than the threshold being 1 and a pixel value less than the threshold being 0 and causes the display 135 as the display to display an image after the binarization processing by the display control function 150i, for example.

### Second Modification of First Embodiment

At step S130, the processing circuitry 150 may perform processing to expand the first region image 3 by the correction function 150c to generate the corrected image 4. As an example, the processing circuitry 150 performs morphology processing, which is known processing, for example, by the correction function 150c to generate the pancreas mask image, which is the first region image 3.

As another example, at Step S130, the processing circuitry 150 may perform processing on the first region image 3 by region growing, which is known processing, by the correction function 150c to generate the corrected image 4 from the first region image 3. In this case, the processing circuitry 150 may use region growing starting from the center of the first region image 3, for example, by the correction function 150c to generate the corrected image 4 from the first region image 3.

As still another example, the processing circuitry 150 may perform processing to smooth the first region image 3 by the correction function 150c to generate the corrected image 4.

### Third Modification of First Embodiment

The first embodiment describes a case in which, at Step S130, the processing circuitry 150 performs the blurring processing on the first region image 3 by the correction function 150c to generates the corrected image 4. However, embodiments are not limited to this example. In an embodiment, the processing circuitry 150 may perform first correction to clarify the boundary of the first region on the first region image 3 before the processing at Step S130 by the correction function 150c and then perform second correction to blur the boundary of the first region by performing the processing at Step S130 to generate the corrected image 4, for example.

Examples of the first correction to clarify the boundary of the first region include a method of performing region correction on the vicinity of the contour of the first region. Examples of the method of region correction include image processing such as graph cut segmentation. Graph cut segmentation is a method of dividing a region by constructing a graph based on a foreground seed and a background seed and minimizing a designed energy function. As a method of clarifying the boundary of the first region, region correction may be performed on the vicinity of the contour of the first region, for example.

As another example, after the end of the processing at Step S130, the processing circuitry 150 may further perform binarization, noise removal such as small region removal, or the like as postprocessing on the corrected image 4 by the correction function 150c. In the second region generated by the second inference function 150d, the pixels may be coupled to each other, and only a largest coupled region may be taken out, or the volume, area, or the like may be calculated from regions, and regions of a certain value or less may be removed, for example. The peripheral part of the generated second region image and a region connected thereto may be removed.

### Fourth Modification of First Embodiment

The above describes a case in which, at Step S140, the processing circuitry 150 infers the image of the second region by the second inference function 150d. However, embodiments are not limited to this example. As an example, at step S140, in addition to the processing at Step S140 already described or in place of the processing at Step S140, the processing circuitry 150 may infer the presence or absence of the second region by the second inference function 150d. That is, the processing circuitry 150 outputs 1 if the second region is included in the input image 1 and 0 if the second region is not included in the input image 1 as a result of inference by the second inference function 150d.

As another example, at Step S140, the processing circuitry 150 may output a probability that the second region is included in the input image 1 as a result of inference by the second inference function 150d.

At Step S120, in addition to generation of the first region image 3, which is the image of the pancreas region, the processing circuitry 150 may infer the first region by performing processing to generate a bounding box surrounding the first region or processing to crop the first region, for example.

### Second Embodiment

In the first embodiment, for the parameter used in the processing in which the processing circuitry 150 generates the corrected image by the correction function 150c at Step S130, a fixed one is used regardless of the input image 1. However, embodiments are not limited to this example. In the second embodiment, the processing circuitry 150 changes the parameter used in the processing to generate the corrected image in accordance with the input image 1.

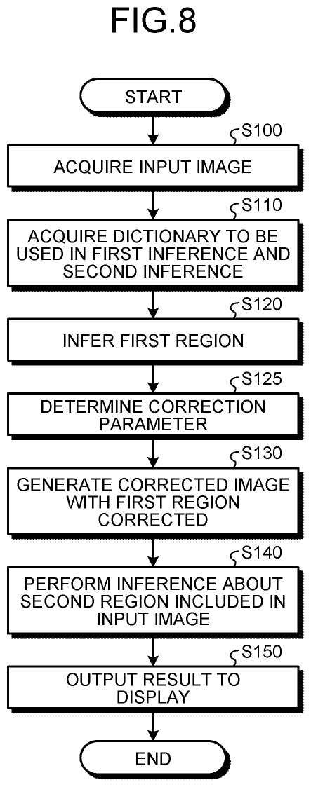

FIG. 8 illustrates a flowchart illustrating a procedure of processing performed by the medical image processing apparatus 100 according to the second embodiment. The pieces of processing other than those at Step S125 and Step S130 are processing common to those of the first embodiment, and thus repeated processing is omitted.

At Step S125, the processing circuitry 150 acquires a correction parameter to be used in generating the corrected image 4 at Step S130 by the correction parameter acquisition function 150e or determines the correction parameter by the correction parameter determination function 150f.

Examples of the correction parameter include the blurring amount σ in the Gaussian filter, which has already been described in the first embodiment.

When the processing circuitry 150 acquires the correction parameter by the correction parameter acquisition function 150e, the processing circuitry 150 acquires the correction parameter from the memory 132, the input device 134, or an external storage device, for example, by the correction parameter acquisition function 150e. The processing circuitry 150 acquires the correction parameter from the memory 132, the input device 134, or the external storage device by the correction parameter acquisition function 150e, for example.

As another example, when the processing circuitry 150 determines the correction parameter by the correction parameter determination function 150f, the processing circuitry 150 determines the value of the correction parameter in accordance with the size of the first region inferred at Step S120 by the correction parameter determination function 150f.

The processing circuitry 150 determines the value of the blurring amount σ of the Gaussian filter, which is the correction parameter, in accordance with the volume of the pancreas region, which is the first region, by the correction parameter determination function 150f, for example. The volume of the pancreas region, which is the first region, can be calculated based on the number of pixels forming the first region, and thus the processing circuitry 150 determines the blurring amount σ of the Gaussian filter, which is the correction parameter, based on the number of pixels forming the first region by the correction parameter determination function 150f.

As an example, for the same size of the input image 1, a smaller volume of the pancreas, which is the size of the first region, gives a smaller total number of pixels in the pancreas region and a greater influence of pixel loss in the pancreas region. Thus, the processing circuitry 150 determines the correction parameter in such a manner that a smaller volume of the pancreas gives a larger blurring amount σ′ of the Gaussian filter by the correction parameter determination function 150f. This processing makes the corrected image 4 an image more expansive than the first region image 3 and can mitigate the influence of the error of the inference performed at Step S140.

The processing circuitry 150 determines the value of the blurring amount σ′ of the Gaussian filter defined by Equation (4) below as the value of the correction parameter by the correction parameter determination function 150f, for example.

$${σ}^{′} = \{ \begin{matrix} & {σ}_{min} ( V < {V}_{min} ) \\ & {σ}_{max} ( V > {V}_{max} ) \\ \frac{{σ}_{min} {\_σ}_{max}}{{V}_{max} {\_V}_{min}} ( V - {V}_{min} ) + & {σ}_{max} ( {V}_{min} \leq V \leq {V}_{max} )\end{matrix} \qquad ( 4 )$$

where V is a pancreas volume of a dataset of interest; Vₘₐₓ is the maximum value of the pancreas volume in the dataset; Vₘᵢₙ is the minimum value of the pancreas volume in the dataset; σₘₐₓ is the maximum value of a blurring amount set value; and σₘᵢₙ is the minimum value of the blurring amount set value. When V=70 cm³, Vₘₐₓ=120 cm³, Vₘᵢₙ=20 cm³, σₘₐₓ=4, and σₘᵢₙ=2, σ′=3, for example.

As another example, the processing circuitry 150 may determine the value of the blurring amount σ based on the upper limit of the size of region loss in the first region image 3, which is the estimated pancreas mask (the value considered to cover the region loss), by the correction parameter determination function 150f. The size of the region loss can be calculated by comparing the correct answer image 2, which is the actual region boundary, and the first region image 3 with each other, for example.

Examples of the correction parameter are not limited to the blurring amount σ of the Gaussian filter described above, and the processing circuitry 150 may determine a filter size or a kernel value as the correction parameter by the correction parameter determination function 150f.

The correction parameter that the processing circuitry 150 determines at Step S125 by the correction parameter determination function 150f may be a value associated with the learned model used for the second inference by the second inference function 150d at Step S140. In this case, however, such a correction parameter is not required to exactly match the value used in the learned model used for the second inference and may be slightly different therefrom.

Thus, the correction parameter set at Step S125 is used by the processing circuitry 150 to generate the corrected image 4 by the correction function 150c at Step S130.

At Step S130, the processing circuitry 150 may generate the corrected image 4 by the correction function 150c as in the first embodiment. In addition, in the second embodiment, further correction processing may be performed if the value of the correction parameter is a specific value, for example. As an example, if the volume of the pancreas is below a certain threshold, the processing circuitry 150 may additionally perform expansion processing to expand the first region image 3 in addition to the blurring processing by the correction function 150c.

Thus, in the second embodiment, the processing circuitry 150 can adjust the value of the parameter for use in the correction processing performed at Step S130. This processing can improve inference accuracy.

### Third Embodiment

The second embodiment describes a case in which the processing circuitry 150 determines the correction parameter value for use in the correction processing at Step S130 in accordance with the first region image 3 by the correction parameter determination function 150f and the like. However, embodiments are not limited to this example. In the third embodiment, the processing circuitry 150 determines parameters for use in the correction processing in accordance with the location in the first region. In other words, the processing circuitry 150 determines a plurality of correction parameters in accordance with a plurality of partial regions forming the first region by the correction parameter determination function 150f.

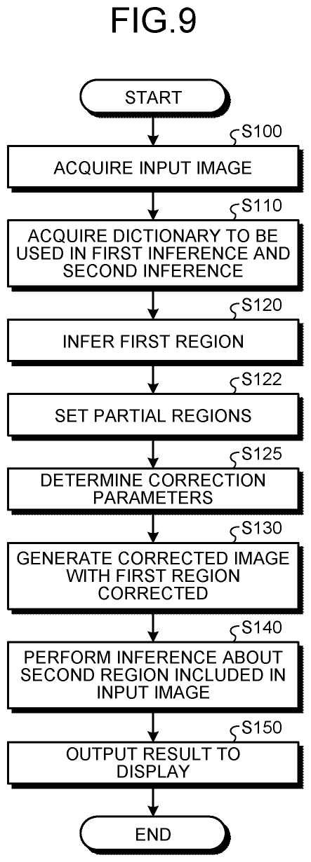

The following describes a procedure of processing performed by the processing circuitry 150 in the third embodiment using FIG. 9. The pieces of processing other than that at Step S122 are the same processing as those of the first embodiment or the second embodiment already described in FIG. 3 or FIG. 8, and thus a repeated description is omitted.

At Step S122, the processing circuitry 150 sets a plurality of partial regions for the first region by the setting function 150h.

As an example, when the first region is the pancreas region, the processing circuitry 150 divides the pancreas region, which is the first region, into the partial regions by the setting function 150h. The processing circuitry 150 divides the pancreas region, which is the first region, into three partial regions, which are a pancreas head region, a pancreas body region, and a pancreas tail region, by the setting function 150h, for example. The pancreas head region is a region connecting to the duodenum, and anatomically, the boundary between the pancreas head part and the pancreas body part is the left side edge of the superior mesenteric vein and portal vein. The pancreas tail part is a region bordering the spleen, and the left side edge of the aorta is the boundary between the pancreas body part and the pancreas tail part.

As an example, in the pancreas mask image, which is the first region image 3, the processing circuitry 150 sets the left half when viewed from a lateral direction in an axial plane as the pancreas head region, sets a right 70% region of the remaining half region as the pancreas tail region, and sets the remaining region as the pancreas body region by the setting function 150h, for example. As another example, the processing circuitry 150 may extract the partial regions by extracting blood vessels from the CT image by the setting function 150h. As still another example, the processing circuitry 150 may set the partial regions by simply dividing the first region image 3 into three parts by the setting function 150h.

Next, at Step S125, the processing circuitry 150 determines the correction parameters in accordance with the partial regions forming the first region by the correction parameter determination function 150f.

In general, 75% of pancreatic cancers are present in the pancreas head part, and pancreatic cancers differ in texture from normal regions, for example. In addition, the pancreas head side is hook-shaped and complex, and thus an inference error is likely to occur in the pancreas head part in the pancreas region inference. Thus, the processing circuitry 150 determines the correction parameters in such a manner that the blurring amount of the pancreas head region is larger than the blurring amount of the pancreas body region and the pancreas tail region by the correction parameter determination function 150f. Thus, at Step S130, the processing circuitry 150 performs the correction processing based on the correction parameters set in accordance with the partial regions by the correction function 150c.

In the third embodiment described above, the processing circuitry 150 determines the correction parameter for each region by the correction parameter determination function 150f. This processing enables the processing circuitry 150 to perform fine-tuned correction processing, improving image quality.

### Modification of Third Embodiment

Embodiments are not limited to the above examples. As an example, at Step S125, the processing circuitry 150 may determine the correction parameter in accordance with the magnitude of the accuracy of the inference about the second region for each partial region by the correction parameter determination function 150f. In other words, at Step S125, the processing circuitry 150 may determine the correction parameter for each partial region in accordance with a prior probability of the accuracy of the inference about the second region by the correction parameter determination function 150f.

As an example, the processing circuitry 150 determines a value obtained by multiplying an estimated value (the prior probability) of the accuracy of the inference about the second region at Step S140 of each partial region by the constant blurring amount σ as the correction parameter for each partial region by the correction parameter determination function 150f. That is, the processing circuitry 150 determines a value obtained by multiplying a variance value indicating the accuracy of the inference about the second region at Step S140 of each of the pancreas head region, the pancreas body region, and the pancreas tail region by the constant blurring amount σ as the correction parameter for each partial region by the correction parameter determination function 150f. This processing can perform correction corresponding to the estimation accuracy of each partial region by making the blurring amount larger for a partial region in which it is expected that the estimation accuracy will be poor, that is, the variance will be large and making the blurring amount smaller for a partial region in which it is expected that the estimation accuracy will be good, that is, the variance will be small.

As another example, the processing circuitry 150 may determine the blurring amount σ, which is the correction parameter, by calculating an interquartile range for each partial region and calculating the variance of outliers exceeding a certain value of the interquartile range, or a value existing at 1.5 times the range or more, for example.

At least one of the embodiments described above can improve inference accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processing apparatus comprising processing circuitry configured to
acquire an input image,
infer a first region image about a first region included in the input image,
generate a corrected image with the first region corrected from the first region image, and
perform inference about a second region included in the input image based on the input image and the corrected image.

2. The image processing apparatus according to claim 1, wherein the processing circuitry generates the corrected image with a shape or distribution of the first region corrected from the first region image.

3. The image processing apparatus according to claim 1, wherein correction processing executed by the processing circuitry is processing to mitigate an influence of an inference error of the first region image on the inference about the second region.

4. The image processing apparatus according to claim 1, wherein correction processing executed by the processing circuitry is processing to increase ambiguity of a shape of the first region image or ambiguity of distribution of the first region image.

5. The image processing apparatus according to claim 1, wherein correction processing executed by the processing circuitry is processing to smooth the first region image.

6. The image processing apparatus according to claim 1, wherein the processing circuitry
acquires a correction parameter for use in the correction processing and
generates the corrected image using the correction parameter.

7. The image processing apparatus according to claim 1, wherein the processing circuitry
determines a correction parameter for use in the correction processing and
generates the corrected image using the correction parameter.

8. The image processing apparatus according to claim 7, wherein the correction parameter is a value associated with a learned model for use in the inference about the second region.

9. The image processing apparatus according to claim 1, wherein the processing circuitry performs learning of a learned model for use in the inference about the first region.

10. The image processing apparatus according to claim 7, wherein the processing circuitry determines the correction parameter based on a number of pixels forming the first region.

11. The image processing apparatus according to claim 7, wherein the processing circuitry determines a plurality of the correction parameters in accordance with a plurality of partial regions forming the first region.

12. The image processing apparatus according to claim 11, wherein the processing circuitry determines the correction parameters for the respective partial regions in accordance with a prior probability of accuracy of inference about the second region.

13. The image processing device according to claim 1, wherein the correction processing executed by the processing circuitry is processing to expand the first region image.

14. The image processing apparatus according to claim 1, wherein the first region is an organ and the second region is a tumor or lesion.

15. The image processing apparatus according to claim 1, wherein the processing circuitry infers a second region image, which is an image of the second region.

16. The image processing apparatus according to claim 1, wherein the processing circuitry infers the presence or absence of the second region.

17. The image processing apparatus according to claim 1, wherein the processing circuitry performs first correction to clarify a boundary of the first region and then performs second correction to blur the boundary of the first region to generate the corrected image.

18. A method of image processing comprising:
acquiring an input image;
inferring a first region image about a first region included in the input image;
generating a corrected image with the first region corrected from the first region image; and
performing inference about a second region included in the input image based on the input image and the corrected image.

19. A non-transitory computer readable medium storing instructions that cause a computer to execute a procedure comprising:
acquiring an input image;
inferring a first region image about a first region included in the input image;
generating a corrected image with the first region corrected from the first region image; and
performing inference about a second region included in the input image based on the input image and the corrected image.
